(19) United States
(12) Patent Application Publication
(10) Pub. No.: US 2004/0006185 A1
(43) Pub. Date: Jan. 8, 2004

(54) Carbamate-functional polymer, curable coating composition thereof, and method of preparing the polymer

(75) Inventors: Donald H. Campbell, Hartland, MI (US); Swaminathan Ramesh, Canton, MI (US)

Correspondence Address: BASF Corporation, Patent Department, 26701 Telegraph Road, Southfield, MI, 48034-2442, US

(73) Assignee: BASF Corporation

(21) Appl. No.: 10/186,982

(22) Filed: Jul. 1, 2002

(51) Int. Cl. C08G 63/91

(52) U.S. Cl. 525/418

(57) ABSTRACT

The present invention is directed to a carbamate-functional polymer that is used to promote the acid etch resistance and recoat adhesion of coating compositions. The polymer is the reaction product of a first compound having a hydroxyl group and a carbamate group, and a carboxylic acid anhydride that is reactive with the hydroxyl group of the first compound. The first compound and the carboxylic acid anhydride form an intermediate compound having a carboxylic acid group and the carbamate group. A second compound has an epoxy group that is reactive with the carboxylic acid group of the intermediate compound for preparing the carbamate-functional polymer. The present invention is also directed to a curable coating composition including the polymer and a method of preparing the polymer.

### FIELD OF THE INVENTION

The present invention generally relates to a carbamate-functional polymer utilized in a curable coating composition. More specifically, the curable coating composition contains the carbamate-functional polymer and a cross-linking agent reactive with a carbamate group of the carbamate-functional polymer upon curing to promote acid etch resistance and to enhance recoat adhesion. The present invention also relates to a method of preparing the carbamate-functional polymer.

### BACKGROUND OF THE INVENTION

Certain carbamate-functional polymers are known in the art. These polymers are generally used to promote the acid etch resistance of coating compositions when the polymers are cross-linked with a cross-linking agent such as an aminoplast resin.

The carbamate functional polymers known in the art are acrylic-based, polyurethane-based, or polyester-based. Although the acrylic-based, carbamate-functional polymers are generally inexpensive to prepare, these particular polymers provide poor recoat adhesion due to the formation of pendant and non-functional acrylic chains during cure. These acrylic chains migrate toward an upper surface of a cured film of a coating composition having the acrylic-based, carbamate-functional polymer and inhibit the adhesion of coating compositions that are subsequently applied to the cured film. It is also known in the art that other properties of the cured film, including scratch and mar resistance, may be compromised when the coating composition includes the acrylic-based, carbamate-functional polymer due to the formation of the acrylic chains described above.

With respect to the polyurethane-based, carbamate-functional polymers of the prior art, it is generally recognized that these particular polymers are unduly expensive relative to other polymers due to a reliance on isocyanates used during the preparation of the polyurethane-based, carbamate-functional polymers. It is also known some polyurethane-based, carbamate-functional polymers have limited functionalities in that they do not include a secondary functionality, such as hydroxyl groups, for optimum cross-linking. Ultimately, this limited functionality may compromise recoat adhesion.

Finally, the polyester-based, carbamate-functional polymers of the prior art generally have limited functionality. For instance, most polyester-based, carbamate-functional polymers are only di-functional. These particular polymers are not highly-branched and, therefore, do not offer maximum functionality. As a result, cross-link densities of cured films of coating compositions that use these limited, polyester-based, carbamate-functional polymers of the prior art are compromised.

In sum, the carbamate-functional polymers of the prior art are characterized by one or more inadequacy. Due to such inadequacies, it is desirable to provide a novel, polyester-based, carbamate-functional polymer that is economical and highly-branched. It is also advantageous to provide a polyester-based, carbamate-functional polymer that promotes acid etch resistance and enhances recoat adhesion.

### SUMMARY OF THE INVENTION

A carbamate-functional polymer is disclosed. The carbamate-functional polymer of the present invention is polyester-based and is the reaction product of a first compound, a carboxylic acid anhydride, and a second compound. The first compound has at least one hydroxyl group and at least one carbamate group, and the carboxylic acid anhydride is reactive with the hydroxyl group of the first compound to form an intermediate compound. The intermediate compound has at least one carboxylic acid group and the carbamate group. The second compound has at least one epoxy group reactive with the carboxylic acid group of the intermediate compound for preparing the carbamate-functional polymer. A curable coating composition, which includes the carbamate-functional polymer, also includes a cross-linking agent that is reactive with the carbamate group of the carbamate-functional polymer.

A method of preparing the carbamate-functional polymer is also disclosed. According to the method of the present invention, the first compound is provided, and the hydroxyl group of the first compound is reacted, or polymerized, with the carboxylic acid anhydride to form the intermediate compound. The carbamate-functional polymer is prepared by reacting the carboxylic acid group of the intermediate compound with the second compound having the at least one epoxy group.

Accordingly, the present invention provides a novel, carbamate-functional polymer that is polyester-based and is therefore economical to use. This carbamate-functional polymer is highly-branched, has multiple functionalities, and is used in coating compositions to promote acid etch resistance and to enhance recoat adhesion.

### DETAILED DESCRIPTION OF THE INVENTION

The carbamate-functional polymer of the present invention is polyester-based and is utilized in curable coating compositions to promote acid etch resistance and to enhance recoat adhesion. Preferably, the carbamate-functional polymer is incorporated into solventborne clearcoat coating compositions to promote acid etch resistance and to enhance recoat adhesion over either waterbome or solventbome basecoat coating compositions. The carbamate-functional polymer, hereinafter referred to as the polymer, is highly-branched as described below.

The polymer comprises the reaction product of a first compound, a carboxylic acid anhydride, and a second compound. The first compound has at least one hydroxyl group and at least one carbamate group. The carboxylic acid anhydride reacts with the hydroxyl group of the first compound to form an intermediate compound having at least one carboxylic acid group and the carbamate group. The second compound has at least one epoxy group that is reactive with the carboxylic acid group of the intermediate compound for preparing the carbamate-functional polymer. In a preferred embodiment of the subject invention, the first compound includes hydroxypropyl carbamate, the carboxylic acid anhydride includes hexahydrophthalic anhydride, and the second compound includes triglycidyl isocyanurate.

The method of preparing the polymer includes the steps providing the first compound having the at least one hydroxyl group and the at least one carbamate group, reacting by polymerizing the carboxylic acid anhydride with the hydroxyl group of the first compound to form the intermediate compound having the at least one carboxylic acid group and the carbamate group, and reacting by polymerizing the second compound having the at least one epoxy group with the carboxylic acid group of the intermediate compound to prepare the carbamate-functional polymer.

In the method of the present invention, the first compound and the carboxylic acid anhydride can be added to a reaction vessel and reacted to form the intermediate compound, and then the second compound can be added to the reaction vessel and reacted with the intermediate compound to form the polymer. Alternatively, the first compound, the carboxylic acid anhydride, and the second compound can all be added to the reaction vessel at the same time, and the first compound and the carboxylic acid anhydride will react first to form the intermediate compound and then the second compound will react. The method steps of the subject invention are preferably conducted at temperatures between 50° C. and 200° C., more preferably between 100° C. and 175° C.

In certain embodiments, where the first compound in the polymer is hydroxypropyl carbamate, a combination is preferably present. The combination is hydroxypropyl carbamate having a primary hydroxyl group and hydroxypropyl carbamate having a secondary hydroxyl group. For descriptive purposes, chemical representations of hydroxypropyl carbamate with the primary hydroxyl group and hydroxypropyl carbamate with the secondary hydroxyl group are respectively disclosed below.

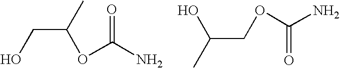

Hydroxypropyl carbamate has one hydroxyl group and one carbamate group. However, it is to be understood that other compounds having a plurality of hydroxyl groups and/or a plurality of carbamate groups may also be utilized as the first compound. For instance, a dihydroxyalkyl carbamate, such as dihydroxybutyl carbamate, may be utilized as the first compound.

The first compound is present in an amount from 5 to 50, preferably from 10 to 20, parts by weight based on 100 parts by weight of the carbamate-functional polymer.

The first compound may alternatively be described as a hydroxyalkyl carbamate. The hydroxyalkyl carbamate has from 1 to 20 carbon atoms in the alkyl chain. If the first compound is a hydroxyalkyl carbamate, then it is preferably selected from the group consisting of hydroxymethyl carbamate, hydroxyethyl carbamate, hydroxypropyl carbamate, hydroxybutyl carbamate, and combinations thereof.

In general, hydroxyalkyl carbamates that are suitable for use as the first compound in the present invention are compounds that include the general structure

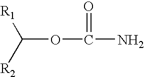

where R₁ is CH₂OH and R₂ is an alkyl or ester having from 1 to 40 carbon atoms. Alternatively, R₁ is H and R₂ is

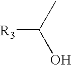

where R₃ is an alkyl or ester having from 1 to 40 carbon atoms.

Generally, hydroxyalkyl carbamates are prepared from a compound having an oxirane group. For example, hydroxypropyl carbamate is prepared from propylene oxide, which is first reacted with CO₂ to form propylene carbonate. Reaction of propylene carbonate with ammonia produces hydroxypropyl carbamate. Thus, the hydroxyalkyl carbamate can be prepared from any compound containing an oxirane group. An additional compound having an oxirane group that is particularly useful is glycidylneodecanoate which is commercially available from Miller-Stephenson Chemical Company, Inc. under its CARDURA® product line, as CARDURA E 10S. Bulky side groups on the hydroxyalkyl carbamates tend to produce lower resin viscosities.

As initially described above, the carboxylic acid anhydride is reacted with the hydroxyl group of the first compound to form the intermediate compound having at least one carboxylic acid group and the carbamate group. The carboxylic acid anhydride may be either an aromatic or non-aromatic cyclic anhydride. The carboxylic acid anhydride is preferably selected from, but not limited to, the group consisting of maleic anhydride, hexahydrophthalic anhydride, methyl-hexahydrophthalic anhydride, tetrahydrophthalic anhydride, phthalic anhydride, succinic anhydride, dodecenylsuccinic anhydride, trimellitic anhydride, glutaric anhydride, and mixtures thereof. Preferably, the carboxylic acid anhydride is hexahydrophthalic anhydride. For descriptive purposes, a chemical representation of hexahydrophthalic anhydride is disclosed below.

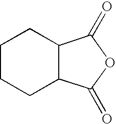

As disclosed above, the hexahydrophthalic anhydride provides an acid functionality. That is, the carboxylic acid group in the intermediate compound originates in the hexahydrophthalic anhydride.

The carboxylic acid anhydride is present in an amount from 10 to 35, preferably from 15 to 30, and most preferably from 20 to 25, parts by weight based on 100 parts by weight of the carbamate-functional polymer. Also, the molar ratio of the first compound to the carboxylic acid anhydride is from 1:3 to 3:1. More specifically, in the preferred embodiment, the molar ratio of the first compound, hydroxypropyl carbamate, to the carboxylic acid anhydride, hexahydrophthalic anhydride, is 1:1. That is, in the preferred embodiment, for every mole of hydroxypropyl carbamate, one mole of hexahydrophthalic anhydride is reacted. For descriptive purposes, a chemical representation of the intermediate compound formed by the reaction of one mole of hydroxypropyl carbamate and one mole of hexahydrophthalic anhydride is disclosed below. The intermediate compound that is formed by the reaction of hydroxypropyl carbamate having the primary hydroxyl group is disclosed first.

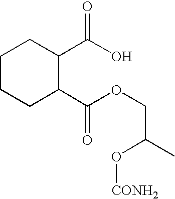

Next, the intermediate compound that is formed by the reaction of hydroxypropyl carbamate having the secondary hydroxyl group is disclosed.

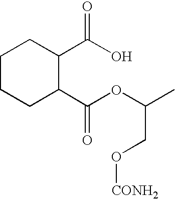

As disclosed above, either intermediate compound that is formed with the reactants of the preferred embodiment has one carboxylic acid group and the carbamate group. The preferred intermediate compound is typically a combination of the two structures disclosed above. The carboxylic acid group of the intermediate compound is formed when the anhydride ring of the hexahydrophthalic anhydride opens and forms ester linkages with the hydroxyl group of the hydroxypropyl carbamate. The hydrogen atom from the hydroxyl group of the hydroxypropyl carbamate reacts with the oxygen atom originally from the anhydride ring to form the carboxylic acid group.

The chemical representations of the intermediate compound that are disclosed above are merely illustrative of the subject invention. The intermediate compound disclosed above has one carboxylic acid group and one carbamate group that are derived from the structures of the first compound, in the preferred embodiment hydroxypropyl carbamate, and from the carboxylic acid anhydride, in the preferred embodiment hexahydrophthalic anhydride. It is to be understood that if alternative compounds are selected for the first compound and for the carboxylic acid anhydride, then the intermediate compound may be different than that which is disclosed above.

To prepare the polymer of the present invention, the second compound having the at least one epoxy group is reacted with the carboxylic acid group of the intermediate compound. More specifically, it is the epoxy group of the second compound that reacts with the carboxylic acid group of the intermediate compound to form the polymer. Preferably, the second compound comprises a triazine compound having the at least one epoxy group. The most preferred second compound is triglycidyl isocyanurate (TGIC) which has three epoxy groups. Other suitable triazine compounds that have at least one epoxy group include, but are not limited to, diglycidyl isocyanurate and di-epoxy bisphenol A (saturated). Di-epoxy bisphenol A is commercially available from Dow Chemical as ERL422 1 (3,4-epoxycyclohexylmethyl-3,4-epoxycyclohexylcarboxylate). One suitable TGIC is commercially available from Vantico, Brewster, N.Y. as Araldite® PT 810. For descriptive purposes, a chemical representation of TGIC is disclosed below.

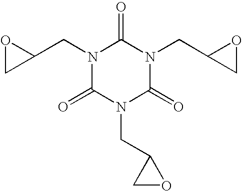

As described above, it is the epoxy groups of the second compound, in the preferred embodiment TGIC, that react with the carboxylic acid group of the intermediate compound. In the preferred embodiment, the hydroxypropyl carbamate and the hexahydrophthalic anhydride are present in molar amounts that are three times greater than the molar amount of the TGIC. As such, there is three times the molar amount of the intermediate compound relative to every mole of TGIC. The epoxy rings of the TGIC open such that one of the two carbon atoms, originally in the epoxy ring of the TGIC, reacts and bonds with an oxygen atom from the carboxylic acid group of the intermediate compound. It is to be understood that in the reaction, the epoxy ring can open in one of two manners such that either one of the carbon atoms of the epoxy ring second manner of epoxy ring opening, which is not chemically represented below, the polymer would include a secondary hydroxyl group. The completed polymer having terminal carbamate functionality and primary hydroxyl functionality is disclosed in the following chemical representation.

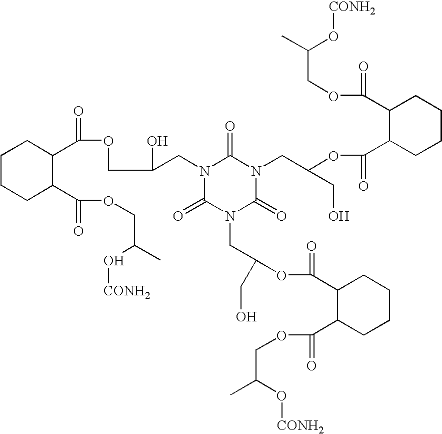

The structural chemical representations disclosed above are merely representative of the invention and clearly rely upon the most preferred elements, hydroxypropyl

The structural chemical representations disclosed above are merely representative of the invention and clearly rely upon the most preferred elements, hydroxypropyl carbamate as the first compound, hexahydrophthalic anhydride as the carboxylic acid anhydride, and TGIC as the second compound. However, the carbamate-functional polymer of the subject invention need not be limited to hydroxypropyl carbamate and hexahydrophthalic anhydride. Instead, the completed polymer can be more generically represented as indicated below.

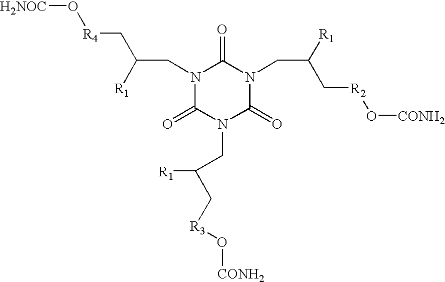

where, R₁ I-s OH or CH₂OH, and R₂, R₃, and R₄ are diesters having from 1 to 40 carbon atoms. R₂, R₃, and R₄ can be the same or different.

The second compound may alternatively comprise an epoxidized vegetable oil. If the second compound includes the epoxidized vegetable oil, then the epoxidized vegetable oil is selected from the group consisting of epoxidized soybean oil, epoxidized linseed oil, epoxidized canola oil, epoxidized sunflower oil, and combinations thereof. For descriptive purposes, a chemical representation one of the epoxidized vegetable oils, specifically epoxidized soybean oil, is disclosed below.

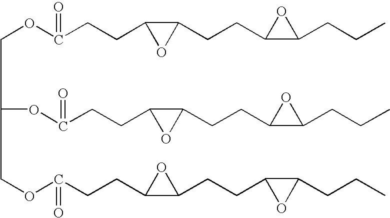

As disclosed above, the epoxidized soybean oil has six epoxy groups. Other vegetable oils may be utilized so long as they have at least one epoxy group. Various epoxidized vegetable oils are commercially available from Cognis Corporation, Cincinnati, Ohio under their Edenol® brand of epoxy plasticizers. Of course, a person of ordinary skill in the art appreciates that natural oils comprise a mixture of compounds and isomers. The structure of epoxidized soybean oil disclosed above is merely representative of one of these compounds.

The epoxy groups of the second compound, in this embodiment epoxidized soybean oil, react with the carboxylic acid group of the intermediate compound. In this embodiment, the hydroxypropyl carbamate and the hexahydrophthalic anhydride are present in molar amounts that are six times greater than the molar amount of the epoxidized soybean oil. As such, there is six times the molar amount of the intermediate compound relative to every mole of epoxidized soybean oil. The epoxy rings of the epoxidized soybean oil open as described above for the TGIC. That is, the epoxy rings open such that one of the two carbon atoms, originally in the epoxy ring of the epoxidized soybean oil, reacts and bonds with an oxygen atom from the carboxylic acid group of the intermediate compound. It is to be understood that in the reaction, the epoxy ring can open in one of two manners such that either one of the carbon atoms of the epoxy ring reacts and bonds with the oxygen atom from the carboxylic acid group. In the first manner of epoxy ring opening, which is disclosed below, the polymer includes a primary hydroxyl group. In a second manner of epoxy ring opening, which is not chemically represented below, the polymer would include a secondary hydroxyl group. The completed polymer having terminal carbamate functionality and primary hydroxyl functionality is disclosed in the following chemical representation where the epoxidized soybean oil is utilized as the second compound.

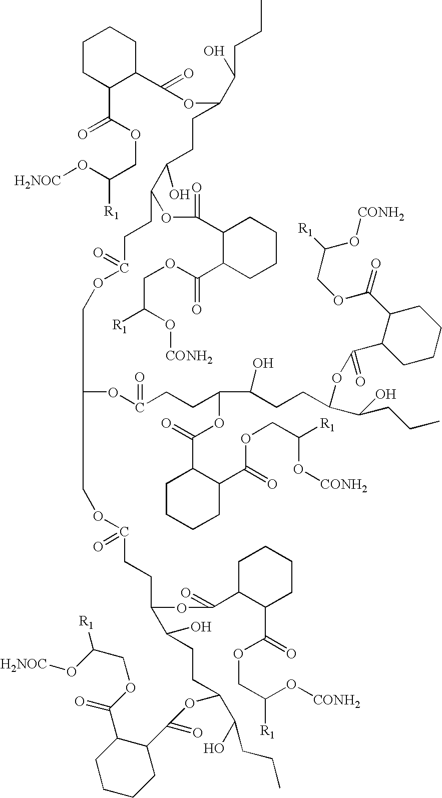

Although generally not preferred, the second compound may include combinations of the triazine compounds having the epoxy groups and of the epoxidized vegetable oils so long as the second compound has at least one epoxy group. Other polyepoxide resins are also suitable for use as the second compound.

The second compound is present in an amount from 1 to 30, preferably from 5 to 25, and most preferably from 10 to 20, parts by weight based on 100 parts by weight of the polymer. The molar ratio of the second compound to the first compound is from 1:10 to 1:1. More specifically, in the preferred embodiment described above selecting TGIC as the second compound, the molar ratio of the second compound, TGIC, to the first compound, hydroxypropyl carbamate, is 1:3. That is, for every epoxy group in the second compound, one mole of the first compound is present. In the alternative embodiment described above selecting epoxidized soybean oil as the second compound, the molar ratio of the second compound, the epoxidized soybean oil, to the first compound, hydroxypropyl carbamate, is 1:6.

The ratio of effective equivalents of the first compound to the carboxylic acid anhydride to the second compound is from 1:2:4 to 4:2:1. Preferably, the ratio of the effective equivalents of the first compound to the carboxylic acid anhydride to the second compound is 1:1:1. The phrase “effective equivalents” as used in connection with this invention means equivalents based upon the number of functional groups that can be expected to actually react out of all available functional groups.

The polymer may further include additives to enhance and/or modify certain physical properties and performance characteristics in the polymer and in coating compositions that utilize the polymer. For instance, various solvents including, but not limited to, toluene, amyl acetate, and isobutanol, n-methyl pyrrolidone, may be included to modify the solids content and viscosity of the polymer. Catalysts such as di-methylaminopyridine (DMAP), may be used to enhance polymerization. Anti-oxidants including, but not limited to, tri-isodecyl phosphite, and anti-yellowing agents including, but not limited to, sodium borohydride may also be used as desired. The additives may be used in the polymer in combinations.

The curable coating composition of the present invention, which includes the carbamate-functional polymer as described above, also includes a cross-linking agent that is reactive with the carbamate group of the polymer. Although the coating composition only requires one cross-linking agent, a combination of cross-linking agents of differing types may be utilized.

Preferably the cross-linking agent includes an aminoplast resin that is reactive with the carbamate group. As understood by those skilled in the art, an aminoplast resin is formed by the reaction product of a formaldehyde and an amine where the preferred amine is a urea or a melamine. Although urea and melamine are the preferred amines, other amines such as triazines, triazoles, diazines, guanidines, or guanamines may also be used to prepare the aminoplast resins. Furthermore, although formaldehyde is preferred for forming the aminoplast resin, other aldehydes, such as acetaldehyde, crotonaldehyde, and benzaldehyde, may also be used.

The aminoplast resin is selected from the group of melamine-formaldehyde resins having a methylol group, an alkoxymethyl group, or both. These groups are preferentially reactive with the carbamate functional group, as opposed to any hydroxyl groups, to ‘cross-link’ the curable coating composition upon cure. Examples of suitable aminoplast resins include, but are not limited to, monomeric or polymeric melamine-formaldehyde resins, including melamine resins that are partially or fully alkylated using alcohols that preferably have one to six, more preferably one to four, carbon atoms, such as hexamethoxy methylated melamine; urea-formaldehyde resins including methylol ureas and siloxy ureas such as butylated urea formaldehyde resin, alkylated benzoguanimines, guanyl ureas, guanidines, biguanidines, polyguanidines, and the like. Monomeric melamine formaldehyde resins are particularly preferred. The preferred alkylated melamine formaldehyde resins are commercially available from Monsanto Corp., St. Louis, Mo., under the trademark RESIMENE 747 or from Cytec Industries, Stamford, Conn., under the trademark CYMEL 323.

Because the polymer of the present invention has terminal carbamate groups and because the aminoplast is reactive with these carbamate groups, ether linkages which result from a hydroxyl group—aminoplast cure, and which are particularly susceptible to acid etch, can be avoided as the primary cross-linking mechanism. To accomplish this, the amount of the cross-linking agent, in the preferred embodiment an aminoplast resin, is limited so that the cross-linking agent reacts only with the available carbamate groups in the polymer. That is, in the preferred embodiment, the aminoplast cross-linking agent reacts preferably with available carbamate groups before any substantial reaction with the hydroxyl groups that are present in the completed polymer. It is therefore possible to control the amount of undesirable ether linkages that are formed when cross-linking the polymer and the cross-linking agent. The amount of cross-linking agent can be increased if cross-linking with the hydroxyl groups is desired for whatever reason.

Although not necessarily preferred, an alternative cross-linking agent for use in the subject invention is a polyisocyanate cross-linking agent. The most preferred polyisocyanate cross-linking agent is a diisocyanate. The polyisocyanate cross-linking agent can be an aliphatic polyisocyanate, including a cycloaliphatic polyisocyanate, or an aromatic polyisocyanate. The term “polyisocyanate” as used herein refers to any compound having a plurality of isocyanate functional groups on average per molecule. Polyisocyanates encompass, for example, monomeric polyisocyanates including monomeric diisocyanates, biurets and isocyanurates of monomeric polyisocyanates, extended poly-functional isocyanates formed by reacting one mole of a diol with two moles of a diisocyanate or mole of a triol with three moles of a diisocyanate, and the like. Aliphatic polyisocyanates are preferred when the coating composition is used as an automotive topcoat composition. Useful examples include, without limitation, ethylene diisocyanate, 1,2-diisocyanatopropane, 1,3-diisocyanatopropane, 1,4-butylene diisocyanate, lysine diisocyanate, 1,4-methylene bis (cyclohexyl isocyanate), isophorone diisocyanate, toluene diisocyanate, the isocyanurate of toluene diisocyanate, diphenylmethane 4,4′-diisocyanate, the isocyanurate of diphenylmethane 4,4′-diisocyanate, methylenebis-4,4′-isocyanatocyclohexane, isophorone diisocyanate, the isocyanurate of isophorone diisocyanate, 1,6-hexamethylene diisocyanate, the isocyanurate of 1,6-hexamethylene diisocyanate, 1,4-cyclohexane diisocyanate, p-phenylene diisocyanate, triphenylmethane 4,4′,4″-triisocyanate, tetramethyl xylene diisocyanate, and metaxylene diisocyanate.

Generally, the polymer is present in an amount from 65 to 90, preferably from 75 to 90, parts by weight based on 100 parts by weight of the coating composition, and the cross-linking agent is present in an amount from 1 to 35, preferably from 5 to 25, and most preferably from 7 to 15, parts by weight based on 100 parts by weight of the coating composition. The ratio of effective equivalents of the carbamate-functional polymer to the cross-linking agent is from 3:1 to 1:3.

The curable coating composition may also include one additive or a combination of additives. Such additives include, but are not limited to, solvents, catalysts, hindered amine light stabilizers (HALs), ultra-violet absorbers (UVAs), rheology control agents, anti-yellowing agents, adhesion promoting agents, and the like. Specific examples of some of the above additives include n-methyl pyrrolidone and oxo-hexyl acetate as solvents to effect such characteristics as pop and sag resistance, and polybutyl acrylate, fumed silica, and silicone as rheology control agents, Because the most preferred curable coating composition is a solventborne clearcoat coating composition, the most preferred additives are HALs and UVAs.

It is to be understood that, especially in solventbome clearcoat coating compositions, the completed polymer of the present invention may also be used as a co-polymer, i.e., co-resin, in combination with a primary resin that is also reactive with the cross-linking agent. That is, the coating composition may comprise a primary resin in addition to the completed polymer of the present invention. Possible primary resins include, but are not limited to, other carbamate- or hydroxy-functional polyacrylates, polyesters, or polyurethanes, and combinations thereof. Of course, if the completed polymer is used as a co-resin, then it would be present in amounts significantly less than 65 parts by weight based on 100 parts by weight of the coating composition.

Articles, such as automotive body panels and the like, may be coated by a method for coating such articles that is disclosed in the present invention. This method includes the steps of applying, onto the article, the curable coating composition as described above, and curing the curable coating composition to form a coated article. The curable coating composition is most preferably spray-applied onto the article by methods that are known in the art including, but not limited to, rotary and air-atomized spray processes. The curable coating composition is reacted, or ‘cross-linked’, at temperatures ranging from 100° C. to 175° C. where the cross-linking agent reacts with the carbamate group of the polymer to form the coated article having a cured film of the curable coating composition.

It is to be understood that all of the preceding chemical representations are merely two-dimensional chemical representations and that the structure of these chemical representations may be other than as indicated.

The following examples illustrating the formation of and the use of the carbamate-functional polymer of the present invention, as presented herein, are intended to illustrate and not limit the invention.

### EXAMPLE 1

In Example 1, the polymer was prepared by adding and reacting the following parts, by weight, unless otherwise indicated.

TABLE 1

| | Amount | Amount | Weight |
|---|---|---|---|
| Reactant | (moles) | (grams) | % |
| First Compound | 3.0 | 87.0 | 11.3 |
| Hydroxypropyl carbamate | | | |
| [HPC] | | | |
| Carboxylic Acid Anhydride | 3.0 | 154.0 | 20.0 |
| Hexahydrophthalic anhydride | | | |
| [HHPA] | | | |
| Second Compound | 1.0 | 99.0 | 12.9 |
| Triglycidyl isocyanurate | | | |
| [TGIC] | | | |
| Solvent | N/A | 130.0 | 16.9 |
| Toluene | | | |
| Solvent | N/A | 60.0 | 7.8 |
| Isobutanol | | | |
| Solvent | N/A | 240.0 | 31.1 |
| Amyl acetate | | | |
| TOTAL | — | 770.0 | 100.0 |

Per the above table, Table 1, 87.0 (89.8 actual) grams of HPC, 154.0 grams of HHPA, and 100 grams of toluene were added in a reaction flask. The reaction flask, including the HPC and the HHPA, was heated with a conventional heat supply to a temperature of approximately 100° C. to form the intermediate compound. In this example, the reaction to form the intermediate compound took approximately six hours. After IR Spectroscopy verification to confirm that most (>95%) of the HHPA was reacted, 99.0 grams of TGIC and 30.0 (31.0 actual) grams of toluene were charged to the reaction flask. A slight exotherm was realized with the temperature peaking at approximately 115° C. After IR Spectroscopy verification to confirm that all of the epoxide (from the TGIC) had reacted, i.e., the absence of an epoxide peak, the reaction mixture was cooled to approximately 80 to 90° C., and 240.0 grams of amyl acetate and 60.0 grams of isobutanol were added to fully disperse the completed polymer. The TGIC reacted with the reaction mixture having the HPC and the HHPA within one hour. The polymer of this example had a non-volatile % of 50.2 by weight.

### EXAMPLE 2

In Example 2, the polymer was prepared by adding and reacting the following parts, by weight, unless otherwise indicated.

TABLE 2

| | Amount | Amount | Weight |
|---|---|---|---|
| Reactant | (moles) | (grams) | % |
| First Compound | 3.0 | 87.0 | 12.1 |
| Hydroxypropyl carbamate | | | |
| [HPC] | | | |
| Carboxylic Acid Anhydride | 3.0 | 154.0 | 21.4 |
| Hexahydrophthalic anhydride | | | |
| [HHPA] | | | |
| Second Compound | 1.0 | 99.0 | 13.7 |
| Triglycidyl isocyanurate | | | |
| [TGIC] | | | |
| Solvent | N/A | 130.0 | 18.1 |
| Toluene | | | |
| Solvent | N/A | 250.0 | 34.7 |
| N-methyl pyrrolidone | | | |
| TOTAL | — | 720.0 | 100.0 |

Per the above table, Table 2, 87.0 (90.0 actual) grams of HPC, 154.0 (154.4 actual) grams of HHPA, and 100 grams of toluene were added in a reaction flask. The reaction flask, including the HPC and the HHPA, was heated with a conventional heat supply to a temperature of approximately 111° C. to form the intermediate compound. After approximately one hour, 99.0 grams of TGIC and 30.0 grams of toluene were charged to the reaction flask, and the temperature was set at 105° C. for approximately four hours. After IR Spectroscopy verification to confirm that all of the epoxide (from the TGIC) had reacted, i.e., the absence of an epoxide peak, and to confirm that most (>95%) of the HHPA had reacted, the reaction mixture was cooled to from 70 to 100° C., and 250.0 grams of n-methyl pyrrolidone were added to fully disperse the completed polymer. The TGIC reacted with the reaction mixture having the HPC and the HHPA within one hour. The polymer of this example had a non-volatile % of 58.4 by weight.

### EXAMPLE 3

In Example 3, the polymer was prepared by adding and reacting the following parts, by weight, unless otherwise indicated.

TABLE 3

| | Amount | Amount | Weight |
|---|---|---|---|
| Reactant | (moles) | (grams) | % |
| First Compound | 3.0 | 494.4 | 19.2 |
| Hydroxypropyl carbamate | | | |
| [HPC] | | | |
| Carboxylic Acid Anhydride | 3.0 | 640.0 | 24.8 |
| Hexahydrophthalic anhydride | | | |
| [HHPA] | | | |
| Second Compound | 1.0 | 411.5 | 16.0 |
| Triglycidyl isocyanurate | | | |
| [TGIC] | | | |
| Solvent | N/A | 764.2 | 29.6 |
| N-methyl pyrrolidone | | | |
| Solvent | N/A | 266.4 | 10.3 |
| Amyl acetate | | | |
| Catalyst | N/A | 1.0 | .1 |
| Di-methylaminopyridine | | | |
| [DMAP] | | | |
| TOTAL | — | 2577.5 | 100.0 |

Per the above table, Table 3, 494.4 grams of HPC, 640.0 grams of HHPA, 764.2 grams of n-methyl pyrrolidone (NMP), and 1.0 gram of DMAP were added in a reaction flask. The reaction flask, including the HPC, HHPA, NMP, and DMAP, was heated with a conventional heat supply to a temperature of approximately 80° C. to form the intermediate compound. In this example, the reaction to form the intermediate compound took approximately seven hours. After IR Spectroscopy verification to confirm that most (>95%) of the HHPA was reacted, the temperature was set to approximately 130° C. and 411.5 grams of TGIC were charged to the reaction flask. After one hour, an exotherm was realized with the temperature peaking at approximately 155° C., and the heat supply was removed from the reaction flask until the temperature decreased to approximately 118° C. The temperature was then set to 130° C. and held for approximately five hours until 266.4 grams of amyl acetate was charged to fully disperse the completed polymer. The polymer of this example had a non-volatile % of 60.0 by weight.

### EXAMPLE 4

In Example 4, the polymer was prepared by adding and reacting the following parts, by weight, unless otherwise indicated

TABLE 4

| | Amount | Amount | Weight |
|---|---|---|---|
| Reactant | (moles) | (grams) | % |
| First Compound | 3.0 | 101.0 | 17.7 |
| Hydroxybutyl carbamate | | | |
| [HBC] | | | |
| Carboxylic Acid Anhydride | 3.0 | 154.0 | 26.9 |
| Hexahydrophthalic anhydride | | | |
| [HHPA] | | | |
| Second Compound | 1.0 | 99.0 | 17.3 |
| Triglycidyl isocyanurate | | | |
| [TGIC] | | | |
| Solvent | N/A | 218.0 | 38.1 |
| N-methyl pyrrolidone | | | |
| TOTAL | — | 572.0 | 100.0 |

Per the above table, Table 4, 101.0 grams of HBC, 154.0 grams of HHPA, 99.0 grams of TGIC, and 168.0 grams of NMP were added in a reaction flask. The reaction flask, including all four components, was heated with a conventional heat supply to a temperature of approximately 81° C. to form the completed polymer. The reaction flask was heated at this temperature for a total of about ten hours to form the completed polymer. Throughout the reaction, IR Spectroscopy was utilized to verify that most (>95%) of the HHPA was reacted, and then to verify that all of the epoxide (from the TGIC) had reacted, i.e., the absence of an epoxide peak. Then, 50.0 grams of NMP were added to the reaction flask to fully disperse the completed polymer. The polymer of this example had a non-volatile % of 60.3 by weight.

### EXAMPLES 5 & 6

For Examples 5 and 6, the carbamate-functional polymer from Example 3 was incorporated into a solventbome clearcoat coating composition according to the following table, Table 5.

TABLE 5

| | Example 5 | Example 6 |
|---|---|---|
| Coating Composition | Amount | Amount |
| Component | (grams) | (grams) |
| Carbamate-Functional Polymer | 650.17 | 637.37 |
| [from Example 3] | | |
| Cross-Linking Agent | 71.84 | 0.00 |
| Hexamethoxymethyl melamine | | |
| Resimene ® 747 | | |
| Cross-Linking Agent | 0.00 | 98.46 |
| Methylated melamine | | |
| Cymel ® 323 | | |
| Additive | 21.60 | 21.60 |
| Catalyst | | |
| Nacure ® XC-6206 | | |
| Additive | 4.50 | 4.50 |
| UVA | | |
| Tinuvin ® 400 | | |
| Additive | 10.42 | 10.42 |
| UVA | | |
| Tinuvin ® 384 | | |
| Additive | 6.75 | 6.75 |
| HAL | | |
| Tinuvin ® 123 | | |
| Additive | 0.90 | 0.90 |
| PBA Rheology Control Agent | | |
| Lindron 22 | | |
| Additive | 4.50 | 4.50 |
| Solvent | | |
| N-methyl pyrrolidone | | |
| Additive | 32.89 | 19.07 |
| Solvent | | |
| Oxo-hexyl acetate | | |
| Total | 803.57 | 803.57 |

Nacure® XC-6206 is a blocked sulfonic acid catalyst commercially available from King Industries.

Tinuvin® 400, 384, and 123 are all commercially available from Ciba Specialty Chemicals.

Lindron 22 is a polybutyl acrylate rheology control agent additive that is commercially available from Lindau Chemicals.

The oxo-hexyl acetate is known in the art as Exxate® 600 Fluid and is commercially available from Imperial Oil (Esso Chemical).

Examples 5 and 6 were formulated under mixing with the component amounts included in Table 5. Panels were then prepared by spray applying the solventborne clearcoat coating compositions of Examples 5 and 6 over both a high-solids solventborne basecoat coating composition and a waterbome basecoat coating composition. For the solventbome basecoat coating composition, the solventborne basecoat was applied to 0.6-0.8 mils and, after a suitable flash period, the clearcoat of Examples 5 and 6 was applied on separate panels to 1.7 to 1.9 mils. The two panels, having the solventbome basecoat and the clearcoat of Examples 5 and 6, were both then simultaneously cured for 25 minutes at 275° F. The particular solventbome basecoat coating composition that was utilized was E86KW524S, which is commercially available from BASF Corporation, Southfield, Mich.

For the waterborne basecoat coating composition, the waterbome basecoat was applied to 0.6-0.8 mils and, after a pre-bake period of 10 minutes at 140° F., the clearcoat of Examples 4 and 5 was applied on separate panels to 1.7 to 1.9 mils. The two panels, having the waterbome basecoat and the clearcoat of Examples 4 and 5, were both then completely cured for 25 minutes at 275° F. The particular waterbome basecoat coating composition that was utilized was E202KW703, which is commercially available from BASF Corporation, Southfield, Mich.

The invention has been described in an illustrative manner, and it is to be understood that the terminology which has been used is intended to be in the nature of words of description rather than of limitation. Obviously, many modifications and variations of the present invention are possible in light of the above teachings, and the invention may be practiced otherwise than as specifically described.

What is claimed is:

1. A carbamate-functional polymer comprising the reaction product of:
a first compound having at least one hydroxyl group and at least one carbamate group;
a carboxylic acid anhydride reactive with said hydroxyl group of said first compound to form an intermediate compound having at least one carboxylic acid group and said carbamate group; and
a second compound having at least one epoxy group reactive with said carboxylic acid group of said intermediate compound for preparing said carbamate-functional polymer.

2. A carbamate-functional polymer as set forth in claim 1 wherein said first compound comprises hydroxypropyl carbamate.

3. A carbamate-functional polymer as set forth in claim 1 wherein said first compound comprises a combination of hydroxypropyl carbamate having a primary hydroxyl group and hydroxypropyl carbamate having a secondary hydroxyl group.

4. A carbamate-functional polymer as set forth in claim 2 wherein said carboxylic acid anhydride comprises hexahydrophthalic anhydride.

5. A carbamate-functional polymer as set forth in claim 4 wherein said second compound comprises triglycidyl isocyanurate.

6. A carbamate-functional polymer as set forth in claim 1 wherein said first compound comprises a hydroxyalkyl carbamate.

7. A carbamate-functional polymer as set forth in claim 6 wherein said hydroxyalkyl carbamate is selected from the group consisting of hydroxymethyl carbamate, hydroxyethyl carbamate, hydroxypropyl carbamate, hydroxybutyl carbamate, and combinations thereof.

8. A carbamate-functional polymer as set forth in claim 6 wherein said hydroxyalkyl carbamate has from 1 to 20 carbon atoms in the alkyl chain.

9. A carbamate-functional polymer as set forth in claim 1 wherein said first compound is present in an amount from 5 to 50 parts by weight based on 100 parts by weight of said carbamate-functional polymer.

10. A carbamate-functional polymer as set forth in claim 1 wherein the molar ratio of said first compound to said carboxylic acid anhydride is from 1:3 to 3:1.

11. A carbamate-functional polymer as set forth in claim 1 wherein said carboxylic acid anhydride is selected from the group consisting of maleic anhydride, hexahydrophthalic anhydride, methyl-hexahydrophthalic anhydride, tetrahydrophthalic anhydride, phthalic anhydride, succinic anhydride, dodecenylsuccinic anhydride, trimellitic anhydride, glutaric anhydride, and mixtures thereof.

12. A carbamate-functional polymer as set forth in claim 1 wherein said carboxylic acid anhydride is present in an amount from 10 to 35 parts by weight based on 100 parts by weight of said carbamate-functional polymer.

13. A carbamate-functional polymer as set forth in claim 1 wherein said second compound comprises a triazine compound having said at least one epoxy group.

14. A carbamate-functional polymer as set forth in claim 1 wherein said second compound comprises an epoxidized vegetable oil.

15. A carbamate-functional polymer as set forth in claim 14 wherein said epoxidized vegetable oil is selected from the group consisting of epoxidized soybean oil, epoxidized linseed oil, epoxidized canola oil, epoxidized sunflower oil, and combinations thereof.

16. A carbamate-functional polymer as set forth in claim 1 wherein said second compound is present in an amount from 1 to 30 parts by weight based on 100 parts by weight of said carbamate-functional polymer.

17. A carbamate-functional polymer as set forth in claim 1 wherein the molar ratio of said second compound to said first compound is from 1:10 to 1:1.

18. A carbamate-functional polymer as set forth in claim 1 wherein the ratio of effective equivalents of said first compound to said carboxylic acid anhydride to said second compound is from 1:2:4 to 4:2:1.

19. A carbamate-functional polymer as set forth in claim 1 in combination with a primary resin selected from the group consisting of carbamate-functional polyacrylates, carbamate-functional polyesters, carbamate-functional polyurethanes, hydroxy-functional polyacrylates, hydroxy-functional polyesters, hydroxy-functional polyurethanes, and combinations thereof.

20. A carbamate-functional polymer as set forth in claim 1 further comprising at least one additive selected from the group consisting of solvents, catalysts, anti-oxidants, anti-yellowing agents, and combinations thereof.

21. A carbamate-functional polymer comprising the reaction product of:
a first compound having at least one hydroxyl group and at least one carbamate group;
a carboxylic acid anhydride; and
a second compound having at least one epoxy group.

22. A carbamate-functional polymer as set forth in claim 21 wherein said first compound comprises hydroxypropyl carbamate.

23. A carbamate-functional polymer as set forth in claim 22 wherein said carboxylic acid anhydride comprises hexahydrophthalic anhydride.

24. A carbamate-functional polymer as set forth in claim 23 wherein said second compound comprises triglycidyl isocyanurate.

25. A carbamate-functional polymer as set forth in claim 21 wherein said first compound comprises a hydroxyalkyl carbamate.

26. A carbamate-functional polymer as set forth in claim 21 wherein said carboxylic acid anhydride is selected from the group consisting of maleic anhydride, hexahydrophthalic anhydride, methyl-hexahydrophthalic anhydride, tetrahydrophthalic anhydride, phthalic anhydride, succinic anhydride, dodecenylsuccinic anhydride, trimellitic anhydride, glutaric anhydride, and mixtures thereof.

27. A carbamate-functional polymer as set forth in claim 21 wherein said second compound comprises a triazine compound having said at least one epoxy group.

28. A carbamate-functional polymer as set forth in claim 21 wherein said second compound comprises an epoxidized vegetable oil.

29. A carbamate-functional polymer of the general formula: 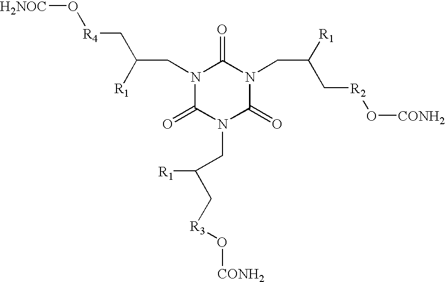
where, R₁ is OH or CH₂OH, and
R₂, R₃, and R₄ are diesters having from 1 to 40 carbon atoms.

30. A curable coating composition comprising:
(A) a carbamate-functional polymer comprising the reaction product of;
(i) a first compound having at least one hydroxyl group and at least one carbamate group,
(ii) a carboxylic acid anhydride reactive with said hydroxyl group of said first compound to form an intermediate compound having at least one carboxylic acid group and said carbamate group, and
(iii) a second compound having at least one epoxy group reactive with said carboxylic acid group of said intermediate compound for preparing said carbamate-functional polymer, and
(B) a cross-linking agent reactive with said carbamate group of said carbamate-functional polymer.

31. A coating composition as set forth in claim 30 wherein said first compound comprises hydroxypropyl carbamate.

32. A coating composition as set forth in claim 31 wherein said carboxylic acid anhydride comprises hexahydrophthalic anhydride.

33. A coating composition as set forth in claim 32 wherein said second compound comprises triglycidyl isocyanurate.

34. A coating composition as set forth in claim 30 wherein said first compound comprises a hydroxyalkyl carbamate.

35. A coating composition as set forth in claim 30 wherein said carboxylic acid anhydride is selected from the group consisting of maleic anhydride, hexahydrophthalic anhydride, methyl-hexahydrophthalic anhydride, tetrahydrophthalic anhydride, phthalic anhydride, succinic anhydride, dodecenylsuccinic anhydride, trimellitic anhydride, glutaric anhydride, and mixtures thereof.

36. A coating composition as set forth in claim 30 wherein said second compound comprises a triazine compound having said at least one epoxy group.

37. A coating composition as set forth in claim 30 wherein said second compound comprises an epoxidized vegetable oil.

38. A coating composition as set forth in claim 30 wherein said cross-linking agent comprises an aminoplast resin reactive with said carbamate group.

39. A coating composition as set forth in claim 38 wherein said aminoplast resin is selected from the group of melamine-formaldehyde resins having a methylol group, an alkoxymethyl group, or both, which are reactive with said carbamate functional group.

40. A coating composition as set forth in claim 30 wherein said cross-linking agent comprises a polyisocyanate.

41. A coating composition as set forth in claim 30 wherein said carbamate-functional polymer is present in an amount from 65 to 90 parts by weight based on 100 parts by weight of said coating composition.

42. A coating composition as set forth in claim 30 wherein said cross-linking agent is present in an amount from 1 to 35 parts by weight based on 100 parts by weight of said coating composition.

43. A coating composition as set forth in claim 30 wherein the ratio of effective equivalents of said carbamate-functional polymer to said cross-linking agent is from 3:1 to 1:3.

44. A coating composition as set forth in claim 30 further comprising (C) a primary resin that is reactive with said cross-linking agent.

45. A coating composition as set forth in claim 44 wherein said primary resin is selected from the group consisting of carbamate-functional polyacrylates, carbamate-functional polyesters, carbamate-functional polyurethanes, hydroxy-functional polyacrylates, hydroxy-functional polyesters, hydroxy-functional polyurethanes, and combinations thereof.

46. A coating composition as set forth in claim 30 further comprising at least one additive selected from the group consisting of solvents, catalysts, hindered amine light stabilizers, ultra-violet absorbers, rheology control agents, anti-yellowing agents, adhesion promoting agents, and combinations thereof.

47. A method of preparing a carbamate-functional polymer comprising the steps of:
(A) providing a first compound having at least one hydroxyl group and at least one carbamate group;
(B) reacting a carboxylic acid anhydride with the hydroxyl group of the first compound to form an intermediate compound having at least one carboxylic acid group and the carbamate group; and
(C) reacting a second compound having at least one epoxy group with the carboxylic acid group of the intermediate compound to prepare the carbamate-functional polymer.

48. A method as set forth in claim 47 wherein the step of (A) providing the first compound is further defined as providing hydroxypropyl carbamate.

49. A method as set forth in claim 48 wherein the step of (B) reacting the carboxylic acid anhydride with the hydroxyl group of the first compound is further defined as reacting hexahydrophthalic anhydride with the hydroxyl group of the hydroxypropyl carbamate to form the first intermediate compound having the carboxylic acid group.

50. A method as set forth in claim 49 wherein the step of (C) reacting the second compound having at least one epoxy group with the carboxylic acid group of the intermediate compound is further defined as reacting triglycidyl isocyanurate with the carboxylic acid group of the intermediate compound to prepare the carbamate-functional polymer.

51. A method as set forth in claim 47 wherein the steps of (A) through (C) are conducted at a temperature ranging from 50° C. to 200° C.

52. A method as set forth in claim 47 wherein the step of (A) providing the first compound is further defined as providing a hydroxyalkyl carbamate selected from the group consisting of hydroxymethyl carbamate, hydroxyethyl carbamate, hydroxypropyl carbamate, hydroxybutyl carbamate, and combinations thereof.

53. A method as set forth in claim 47 wherein the step of (B) reacting the carboxylic acid anhydride with the hydroxyl group of the first compound is further defined as reacting a carboxylic acid anhydride selected from the group consisting of maleic anhydride, hexahydrophthalic anhydride, methyl-hexahydrophthalic anhydride, tetrahydrophthalic anhydride, phthalic anhydride, succinic anhydride, dodecenylsuccinic anhydride, trimellitic anhydride, glutaric anhydride, and combinations thereof, with the hydroxyl group of the first compound to form the first intermediate compound having the carboxylic acid group.

54. A method as set forth in claim 47 wherein the step of (C) reacting the second compound having at least one epoxy group with the carboxylic acid group of the intermediate compound is further defined as reacting a triazine compound having the at least one epoxy group with the carboxylic acid group of the intermediate compound to prepare the carbamate-functional polymer.

55. A method as set forth in claim 47 wherein the step of (C) reacting the second compound having at least one epoxy group with the carboxylic acid group of the intermediate compound is further defined as reacting an epoxidized vegetable oil having the at least one epoxy group with the carboxylic acid group of the intermediate compound to prepare the carbamate-functional polymer.

56. A method of coating an article, said method comprising the steps of:
(A) applying, onto the article, a curable coating composition comprising a carbamate-functional polymer and a cross-linking agent reactive with the carbamate-functional polymer, wherein the carbamate-functional polymer is the reaction product of;
(i) a first compound having at least one hydroxyl group and at least one carbamate group,
(ii) a carboxylic acid anhydride reactive with the hydroxyl group of the first compound to form an intermediate compound having at least one carboxylic acid group and the carbamate group, and
(iii) a second compound having at least one epoxy group reactive with the carboxylic acid group of the intermediate compound for preparing the carbamate-functional polymer; and
(B) curing the curable coating composition to form a coated article.

57. A method as set forth in claim 56 wherein the step of (A) applying the curable coating composition onto the article is further defined as spraying the curable coating composition onto the article.

58. A method as set forth in claim 56 wherein the step of (B) curing the curable coating composition is further defined as reacting the cross-linking agent with the carbamate group of the carbamate-functional polymer to form the coated article.

59. A method as set forth in claim 58 wherein the step of reacting the cross-linking agent with the carbamate group of the carbamate-function polymer is conducted at temperatures ranging from 100° C. to 175° C.

60. An article coated according to the method of claim 56.

61. A cured film prepared according to the method of claim 56.
